(19) United States
(12) Patent Application Publication
(10) Pub. No.: US 2006/0061457 A1
(43) Pub. Date: Mar. 23, 2006

(54) In-vehicle rear seat entertainment system

(76) Inventor: Andrew H. Ferguson, Walnut, CA (US)

Correspondence Address: Andrew H. Ferguson;c/o Drive Mobile Entertainment, 20120 G. Paseo Del Prado, Walnut, CA, 97789, US

(21) Appl. No.: 10/947,256

(22) Filed: Sep. 23, 2004

(51) Int. Cl. B60R 25/10

(52) U.S. Cl. 340/426.34

(57) ABSTRACT

An in-vehicle entertainment system. The system is mounted on the ceiling of the vehicle and faces the rear seat. There is a housing to receive a left and right screen and a switcher mounted in the middle. The switcher has various inputs such as a DVD, music DVD or movie DVD. The audio is received in speakers or headphones in combination with the screens. There can be an auxiliary screen that can be mounted anywhere in the vehicle. The vehicle radio may be connected to the switcher in such a manner to play through the switcher audio system.

### CROSS REFERENCE TO RELATED APPLICATIONS

(none)

### STATEMENT REGARDING FED SPONSORED R & D

(none)

### BACKGROUND OF THE INVENTION

It is known to install LCD monitors in cars, especially in the rear seat for many years and it is desirable to have multiple screen systems installed in the vehicles. In order to achieve such multiple screen systems, installers have either used the rears of headrests to mount screens thereon or had to take independent components and virtually install separate systems which then had to be tied together by complicated wiring systems. Furthermore, the DVD or source unit has to be installed on the floor of the vehicle further complicating the installation and taking up more space. Until now, no one has provided an easy, simple and efficient way to install a complete, multiple, flip-down screen, entertainment system in a vehicle.

### BRIEF DESCRIPTION OF THE INVENTION

The inventive system comprises a dual screen consisting of two flip-down video monitors, a DVD player (or other source units, a switching system and a dual channel AIR transmitter. All of the above components are mounted in a single housing or a shroud. The housing is mounted under the roof of the vehicle or under or within the headliner.

The various components, that is, the screens, DVDs etc. may be modular and can be removed and utilized in various configurations, that is, side-by-side or front to back by using a different housing in each instance.

The system can be tooled to be fixed, if desired, by still using all the same core components and design criteria.

The switching system allows a user to select from three (3) sources, the built-in DVD and two (2) other auxiliary sources such as a camera or game systems.

The switching system provides power for the entire system, allowing for all of the components to be powered up from a single power source from the vehicle's basic electric power supply by way of a cable including a fuse box.

The switching system allows independent 3-way switching of all three (3) sources. Either screen can watch any of the sources independently or simultaneously. The audio of any of the sources can be heard via the AIR transmitter or a wireless FM transmitter.

The switching system allows a user to add a third screen somewhere in the vehicle and provides independent source selection for that screen as well.

The switching system, screens and the DVD are all controlled by a unified remote control.

### BRIEF DESCRIPTION OF THE DRAWINGS

FIG. 1 is an exploded view of a compact installation;

FIG. 2 is a front view of the installed system in a closed state;

FIG. 3 is a side view of the system of FIG. 2;

FIG. 4 is a front view of the installed system in an open state;

FIG. 5 is a side view of the system of FIG. 4;

FIG. 6 is a side view of the installed system in a closed state;

FIG. 7 is an end view of the system of FIG. 6;

FIG. 8 is a side view of the installed system in an open state;

FIG. 9 is an end view of the system of FIG. 8;

FIG. 10 is a first power and layout schematic;

FIG. 11 is a second power and layout schematic.

### DETAILED DESCRIPTION OF THE INVENTION

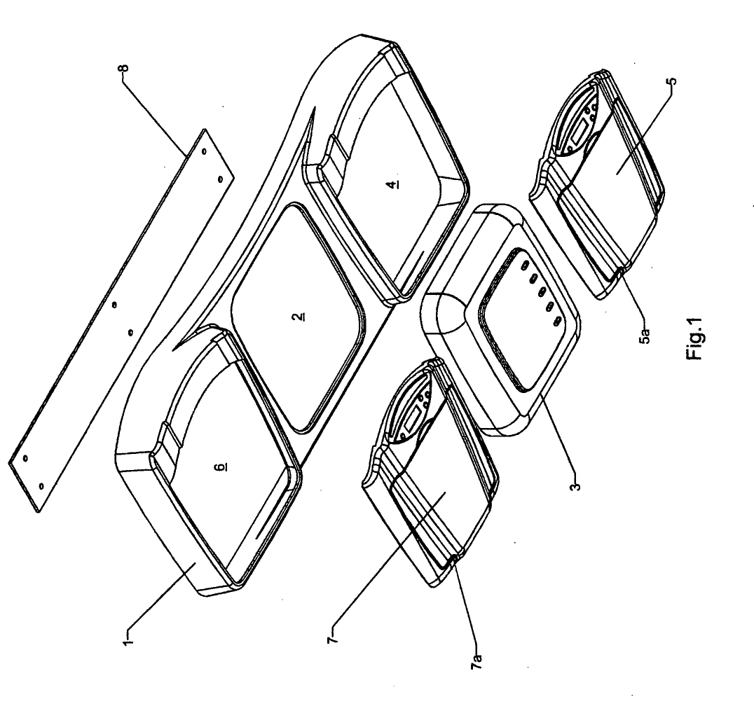

FIG. 1 is an exploded view of the inventive entertainment system. The system will be installed under the roof or the ceiling of the vehicle, preferably within the roof lining in the ceiling. of course, the Fig. shown in FIG. 1 should be read upside down because it is mounted against the ceiling of the vehicle where it is installed. The system is received in a unitary housing 1 having various depressions 2, 4 and 6 therein which, when the components are installed, makes a compact and smooth appearance. For example, there is a switcher 3 (explained below) which will be received within a first center depression 2 of the housing 1. There is a right depression 4 which will receive the video screen 5. The screen 5 is hinged to the housing 1 at 5a. Finally, there is a depression 6 which will receive the video screen 7. The screen 7 is hinged to the housing 1 at 7a. The hinges 5a and 7a enable the screens 5 and 7 to be flipped donwardly so that they can be viewed. The components 3, 5 and 7 can be removed and can be interchanged. The housing 1 can be mounted against the ceiling of the vehicle by way of a mounting plate 8 In the form of a bezel. The bezel 8 can be profiled or trimmed for certain types of roofs or ceilings. The mixer can be profiled so that it can be mounted in a reversible mode.

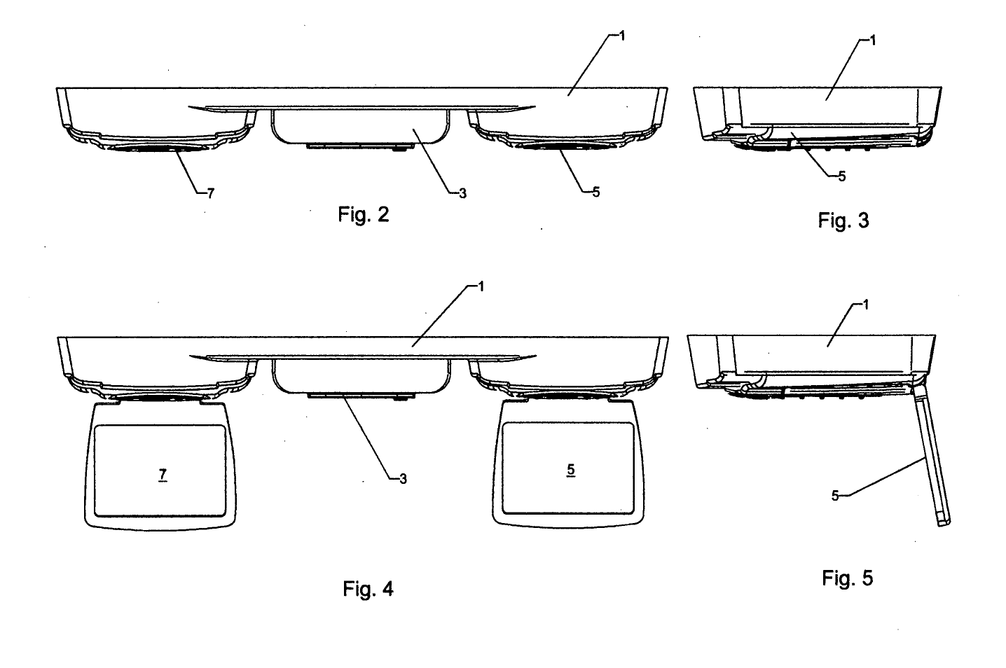

FIG. 2 shows the system in its proper mode after it has been installed. FIG. 2 further shows the system in its closed mode, that is, a front view as seen from the back seat of a vehicle, for example. The same reference characters for the different components as shown in FIG. 1 have been incorporated in this FIG. 2. As a matter of fact, the same reference characters of FIG. 1 have been used throughout FIGS. 3 through 9.

FIG. 3 is a side view of FIG. 2.

FIG. 4 is a front view of the same view of FIG. 2 but in an open position wherein the screens 5 and 7 have been flipped down to be able to be viewed.

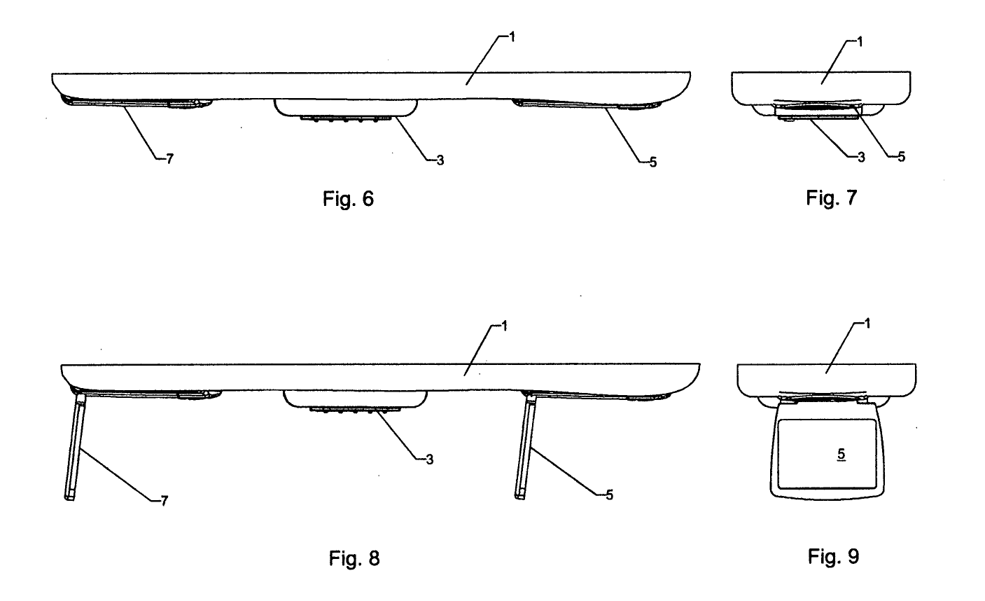

FIG. 5 is a side view of FIG. 4 where the flipped down screen 5 can be seen.

FIG. 6 is a side view of the installed system but in a different orientation.

FIG. 7 is an end view of the system as can be seen in FIG. 6.

FIG. 8 is a side view of the installed system as is shown in FIG. 6 but in an open mode whereby the screens can be seen in a front to back arrangement.

FIG. 9 is a showing of the end view of FIG. 8 where only one screen 5 can be seen.

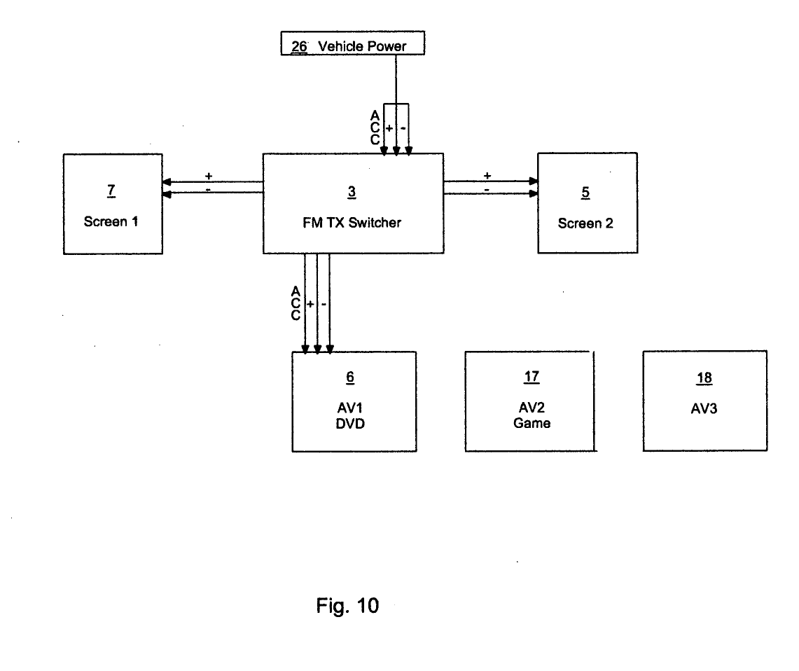

FIG. 10 shows a first power and layout schematic. Again like reference have been used as were shown in FIG. 1. The power is distributed throughout the system via the switcher 3. One power cable is run from the vehicle accessory fuse panel to the switcher 3 in the overhead. The cable has a minus power, constant memory or positive power as is marked in the three cables coming from the Vehicle power. This single cable is connected to the switcher 3.

From here the power supply in the multiplex switcher 3 redistributes the power through three (3) separate connectors that provide power independently to the two screens 5 and 7 and the DVD AV1 player. The DVD player can also take the form of a game player AV2 or a music player and other components AV3.

The FM TX is within the circuit board of the switcher 3 and is therefore powered internally. The AIR transmitters are located in the screens and are powered up through the screen circuitry.

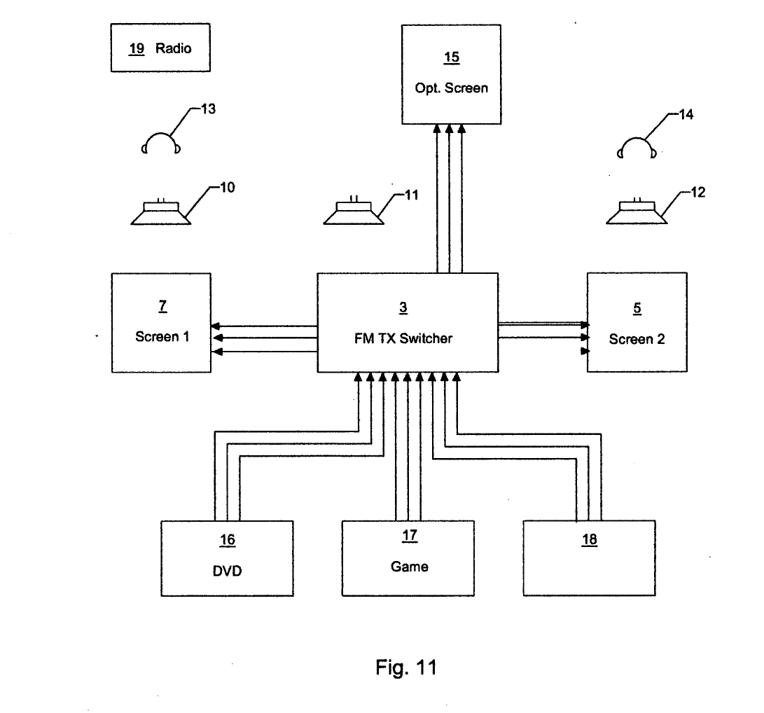

FIG. 11 represents a second power and layout schematic. There is still the basic multiplex FM TX switcher 3 which powers the screens 5 and 7 as was shown in FIG. 10. However an optional screen 15 which is also powered by the switcher 3. The optional screen 15 may be placed anywhere within the vehicle.

With two screens in a side-by-side or front to back—relationship and the switcher 3 in the middle along with an FM transmitter and at least 3 auxiliary inputs, the system should allow the user to select any source. The three auxiliary inputs can consist of a DVD 16, a game player 17 or a music player 18 and may operate from either screen or watch from any source on both screens. The audio should be available from any of the sources via AIR headphones 13 and 14. The FM transmitter, which is built into the switcher 3, would be able to select any of the sources selectively and independently and wirelessly transmit it to the vehicle audio system, such as the speakers 10, 11 and 12, via the FM radio 19 into the vehicle stereo.

What I claim is:

1. An in-vehicle entertainment system adapted to be mounted on the ceiling of a vehicle, said entertainment system comprising a housing, said housing receiving a left and right video screen and a switcher component mounted in between said screens, means for powering said system from a power source of said vehicle.

2. The entertainment system of claim 1, wherein each of said screens has a hinge thereon to be flipped down for viewing from a back seat of said vehicle.

3. The entertainment system of claim 1, wherein each of said screens and said switcher are mounted in recesses in said housing.

4. The entertainment system of claim 1, wherein said switcher includes a DVD.

5. The entertainment system of claim 1, wherein said switcher includes a game DVD.

6. The entertainment system of claim 1, wherein said switcher includes an auxiliary screen to be mounted anywhere in said vehicle.

7. The entertainment system of claim 1 including at least three additional inputs into said switcher.

8. The entertainment system of claim 7, wherein said at least two additional inputs are selected from the group consisting of a music DVD, game DVD or a movie DVD.

9. The entertainment system of claim 1 including an input into said switcher from an FM radio mounted in said vehicle.

10. The entertainment system of claim 9, wherein an audio from said radio is received in speakers located within said screens.

11. The entertainment system of claim 10, wherein said audio is received in headphones.
